(19) United States
(12) Patent Application Publication
(10) Pub. No.: US 2014/0164472 A1
(43) Pub. Date: Jun. 12, 2014

(54) COLLABORATIVE SHARING OF CONTEXTUALLY SIMILAR CACHE DATA TO REDUCE NETWORK USAGE

(71) Applicant: INTERNATIONAL BUSINESS MACHINES CORPORATION, Armonk, NY (US)

(72) Inventors: Gary D. Cudak, Creedmoor, NC (US); Lydia M. Do, Raleigh, NC (US); Christopher J. Hardee, Raleigh, NC (US); Adam Roberts, Moncure, NC (US)

(73) Assignee: INTERNATIONAL BUSINESS MACHINES CORPORATION, Armonk, NY (US)

(21) Appl. No.: 13/709,304

(22) Filed: Dec. 10, 2012

Related U.S. Application Data
(63) Continuation of application No. 13/706,407, filed on Dec. 6, 2012.

(51) Int. Cl. H04L 29/08

(52) U.S. Cl. CPC H04L 67/1078
USPC 709/202

(57) ABSTRACT

Wireless user devices can independently download and cache data from websites over a wireless communications network. In response to a request for data, a first user device may receive data directly from a second user device instead of receiving data over the communications network, if the data satisfies the request. Near field communications may be used for direct communication between user devices within range of the near field communication. Metadata describing the cached data may be stored in association with the cached data. Each user device may advertise its metadata and allow it to be searched by another user device that is requesting data. If the request can be satisfied with cached data stored by a selected user device, then the cached data is received directly from the selected user device, but the data is otherwise received over the communications network.

### CROSS-REFERENCE TO RELATED APPLICATIONS

This application is a continuation of co-pending U.S. patent application Ser. No. 13/706,407, filed on Dec. 6, 2012.

### BACKGROUND OF THE INVENTION

1. Field of the Invention

The present invention relates to wireless communications networks and methods of reducing network traffic.

2. Background of the Related Art

A wireless service agreement is a contract between a wireless communication network service provider and a user, where the service provider agrees to provide wireless network services to the user at agreed upon rates during an agreed upon time period. If the user desires to have access to services beyond voice and text messaging, such as wireless internet access, then the wireless service agreement may describe a wireless data plan. A “wireless data plan” is group of additional terms and conditions that govern the delivering of internet access and the charges associated with using the internet access.

Many wireless data plans are structured to provide a fixed initial amount of data usage for a fixed price. For example, the user may be charged $25 for one gigabyte (GB) of data downloaded from the network. Accordingly, the one gigabyte of data may be referred to as the “contract amount” of data. However, if the user's data usage for a given period exceeds the contract amount, then the user is said to have gone over the limit. The service provider will then charge the user an additional amount for the additional data usage.

Although the foregoing example of a wireless data plan provides data usage in blocks, it is also possible for a data plan to be provided in smaller blocks or on a continuous pricing model. Regardless of the size of the blocks, the user is charged in proportion to the amount of data downloaded from the network, such as may be measured in gigabytes. In an alternative example, a user may be charged based on the number to times that a user accesses the network. However, any usage plan that charges for each incremental use of the network can become expensive for the user.

### BRIEF SUMMARY OF THE INVENTION

One embodiment of the present invention provides a method, comprising a plurality of user devices independently downloading data from websites over a communications network in response to user-entered requests for data, and each of the plurality of user devices caching the data that the user device has downloaded over the communications network. The method further comprises a first one of the plurality of user devices, in response to a first user entering a request for data, receives data directly from a second one of the plurality of user devices instead of receiving data over the communications network, wherein the data received from the second user device satisfies the request.

### BRIEF DESCRIPTION OF THE SEVERAL VIEWS OF THE DRAWINGS

FIG. 1 is a diagram of first and second user devices capable of performing a transaction.

FIG. 2 is a diagram of a computer system that may be used by a transaction service provider.

FIG. 3 is a flowchart of a method in accordance with one embodiment of the present invention.

FIG. 4 is a flowchart of a method in accordance with another embodiment of the present invention.

### DETAILED DESCRIPTION OF THE INVENTION

One embodiment of the present invention provides a method, comprising a plurality of user devices independently downloading data from websites over a communications network in response to user-entered requests for data, and each of the plurality of user devices caching the data that the user device has downloaded over the communications network. The method further comprises a first one of the plurality of user devices, in response to a first user entering a request for data, receiving data directly from a second one of the plurality of user devices instead of receiving data over the communications network, wherein the data received from the second user device satisfies the request.

In one optional feature, each of the plurality of user devices may selectively cache the data that the user device has downloaded. For example, one of the user devices may cache only files having greater than a predetermined quantity of data. Alternatively, the user device may cache only video files. Still further, a user device may only cache files determined to have greater than a predetermined popularity, since these are the files that are most likely to be in demand by other user devices. Popularity can be tracked by the website providing the data to the client user device. For example, the website can count the total number of downloads of the data or content or determine rate of download of the data or content (i.e., downloads per period of time). When the data or content has been shown to be popular, the website may include a popularity parameter in metadata associated with the data. Alternatively, popularity may be measured by “trending”, which includes the analysis of recent social media traffic, such as Twitter feeds and comments, as well as updates to various websites. A high popularity indicates that the user device should cache the data for the purpose of sharing with other user devices.

Preferably, each of the plurality of user devices will store the cached data in association with metadata describing one or more characteristic of the cached data. Accordingly, the metadata can be used to determine whether data cached by the second user device will satisfy the first user's request. Non-limiting examples of the one or more characteristic of the cached data include context, keywords, source, timestamp, and combinations thereof.

In a further optional feature, the first user device may cache the data that it received directly from the second user device. In this manner, the first user device may pass along the data, such as a popular video clip, to yet another user device without need to download the video from the wireless communications network.

In a preferred embodiment, the metadata that is stored on each of the plurality of user devices is advertised to the rest of the plurality of user devices. Advertising the metadata may include broadcasting at least a portion of the metadata, or responding to requests received from other user devices. Regardless of the exact details of the interaction between user devices, the first user device may search the advertised metadata stored on each of the plurality of user devices to locate metadata indicating that the associated data would satisfy the request, which request may be in the form of a uniform resource locator entered into a web browser. The first user device may then receive data directly from the second user device, where the data is identified by being associated with the located metadata. The metadata is preferably advertised using a near field communication signal that is received by those user devices within range of the near field communication signal. The near field communication allows the first and second user devices to exchange data directly without use of the wireless communications network.

Embodiments of the invention may also limit the data that a user device will cache. Such limits may be tailored to the user's needs or an average user's need, such that the most relevant data is cached and other data is not cached or not retained for extended periods. For example, all data may be cached for a predetermined period of time. Optionally, the predetermined period of time may vary according to the type or source of the data. This may be useful for files such as news stories that may lose their relevance over time.

When the metadata stored on each of the plurality of user devices has been advertised to the rest of the plurality of user devices, one of those user devices (i.e., a first user device) may search the advertised metadata in an attempt to locate metadata indicating that the associated data is contextually similar to the requested data. Many tests or conditions may be developed for determining whether certain data is “contextually similar” to requested data. In one embodiment, data is found to be contextually similar to the requested data when the associated metadata contains one or more keywords that appeared in the request or on a webpage referenced in the request. In an alternative embodiment, data is found to be contextually similar to the requested data when the metadata indicates that the source provides data of the same type as the data requested. Accordingly, two different websites may be contextually similar if they are both directed to national news, weather reports, or sports scores.

Further embodiments of the invention may include displaying a prompt to a user on the first user device. For example, a prompt may be displayed on the first user device allowing the first user to select whether to receive data directly from the second device or receive data from the communications network. Beneficially, the prompt that is displayed on the first user device may identify the data that is available from the second device.

In a related embodiment, if a first user device identifies, from among the plurality of user devices, multiple user devices having data that is contextually similar to the data requested, then a prompt may be displayed on the first user device allowing the first user to select a user device from among the multiple user devices. The first user device would then receive the requested data directly from the selected user device. Optionally, the prompt that is displayed on the first user device may also identify the data that is available from each of the multiple user devices. In a further option, the prompt may further identify, for each of the multiple user devices, a device type, proximity, strength of signal, or combination thereof. The user may consider any or all of the information in the prompt when selecting where to obtain the requested data. In a still further option, the first user device may store a list of data sources that, when identified in the metadata, make data unacceptable regardless of the data being contextually similar. Such a list may be stored as a user preference that allows the user to not be bothered with otherwise contextually similar data that is from a website or other source that the user does not want to use.

Embodiments of the method may further receive user input enabling the first user device to share cached data. In response to enabling the first user device to share cached data, the first user device may increase the amount of data that is cached by the first user device. In other words, the device will cache a larger amount of data when there is a chance that the data might be shared with another user device.

In yet another embodiment, a local server of an internet service provider may be involved in communicating the downloading data from websites to the plurality of user devices. Accordingly, the local server may cache the data that is being downloaded and keep the data available for a user device to access without returning to the website that originated the downloaded data. A first one of the plurality of user devices, in response to a first user entering a request for data, may receive data directly from the local server instead of receiving data from the website, wherein the data received from the local server satisfies the request. As with previous embodiments, when contextually similar data has been identified on multiple sources from amount the plurality of user devices and the local server, a prompt may be displayed on the first user device allowing the first user to select a source from among the multiple sources, wherein the first user device receives data directly from the selected source whether it is the local server or one of the other user devices.

Another embodiment of the present invention provides a computer program product including computer usable program code embodied on a tangible computer usable storage medium for controlling a wireless user device. The computer program product comprises computer usable program code for caching data downloaded from websites over a cellular communications network in response to user-entered requests for data; computer usable program code for establishing near field communication directly between the wireless user device and other user devices within range of the near field communication; computer usable program code for searching metadata stored by the other user devices, wherein the metadata is stored in association with cached data and describes one or more characteristic of the cached data; computer usable program code for receiving a user request for data; computer usable program code for determining if the user request can be satisfied with cached data stored by a selected one of the other user devices; computer usable program code for receiving cached data directly from the selected user device when the cached data satisfies the user request; and computer usable program code for receiving data over the communications network when the cached data stored on the other user devices does not satisfy the user request. It should be recognized that the computer program product may further include computer usable program code for implementing any one or more aspect of the methods disclosed herein.

In one embodiment of the computer program product, the computer usable program code for determining if the user request can be satisfied with cached data stored by a selected one of the other user devices, includes computer usable program code for determining if the cached data is contextually similar to the requested data.

Another embodiment of the computer program product includes computer usable program code for displaying a prompt allowing a user to select whether the user device will receive the cached data from the selected user device or receive data over the communications network.

Yet another embodiment of the computer program product includes computer usable program code for advertising the metadata stored on the user device to the other user devices within range of the near field communication. Optionally, the computer program product may further include computer usable program code for receiving user input enabling or disabling the capability of the user device to advertise metadata and share cached data associated with the metadata, and computer usable program code for increasing the amount of data cached by the user device in response to enabling the capability of the user device to advertise metadata and share cached data associated with the metadata.

It should be recognized that embodiments of the invention, disclosed herein, may reduce network traffic over a first network through the use of user devices that can collaborate and share locally cached data that satisfies a request of one of the other user devices. Although the discussion above is often directed to near field communications, the user devices may communicate data over other secondary communication modes or networks that reduce network traffic on the first network. In one specific example, the first network is a cellular network, such as a 3G or 4G network, and the secondary communications use near field communications, such as implemented by the Bluetooth standard.

In some embodiments of the invention, all of the steps from initiation to completion of the electronic transaction occur entirely within and between the first and second user devices. For example, near field communications may be completed between an application running on a first user device (first mobile communications device) and an application running on the second user device (second mobile communications device) without involving a third party (a wireless network service provider or website). In other embodiments, some of the steps may be performed by a third party internet service provider (ISP).

In various embodiments, the user devices may be mobile communications devices, such as a mobile telephone, notebook computer, tablet computer, e-reader, or other category of mobile electronics device. However, in other embodiments, one or more user device may be a mobile communications device while one or more other user devices are of a type that are not considered to be mobile. For example, a user device that is not generally considered to be mobile may include a point-of-sale computer or terminal, a stationary kiosk computer, a home or business desktop computer, a hard-wired telephone, television, set-top box or other such electronic device that may now or in the future have the capabilities to participate in an electronic communication as disclosed herein.

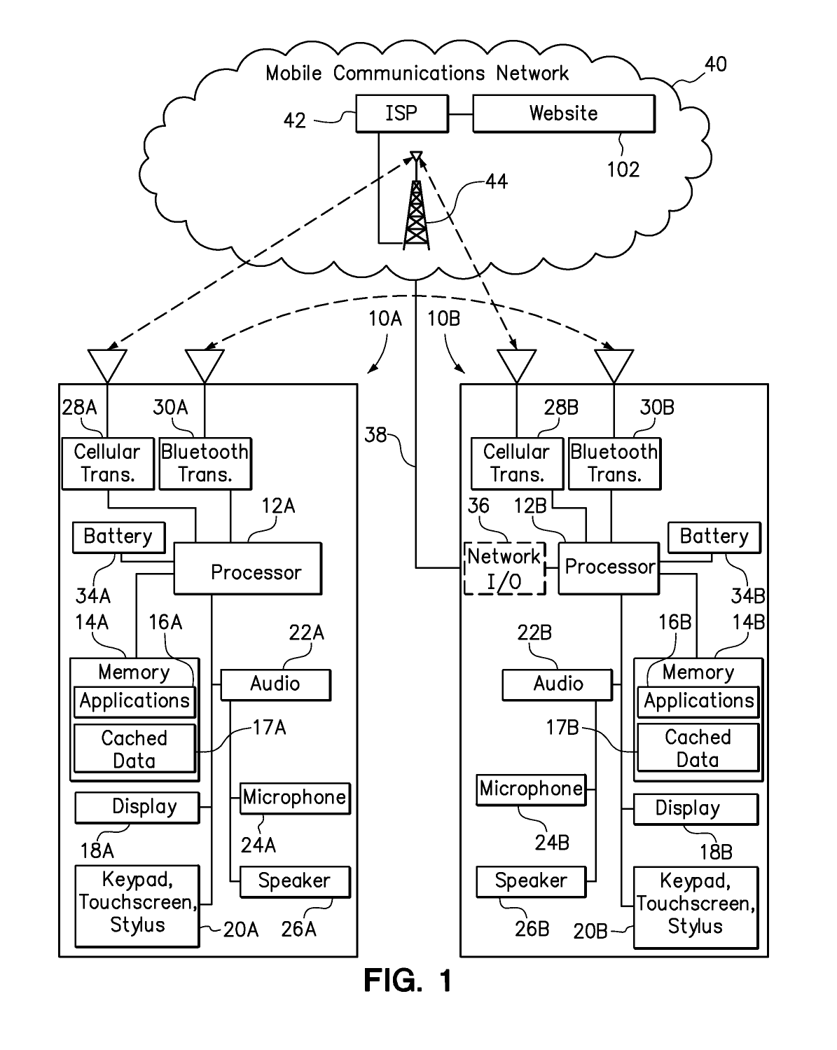

FIG. 1 is a diagram of a first user device 10A and a second user device 10B capable of participating in embodiments of the invention. The first and second user devices may be, and are shown as being, substantially identical. Accordingly, the description here describes the first user device 10A as being representative of the second user device. In an actual implementation of the invention, it is not necessary for the two user devices to be substantially identical.

In this non-limiting example, the first user device 10A includes a processor 12A in communication with memory 14A, which may include one or more application 16A. The processor 12A is also in communication with various components over an input/output bus, including a display 18A, a keyboard, touch screen or stylus 20A, and an optional audio module 22A that includes a microphone 24A and a speaker 26A. One or more wireless user devices may also include a cellular transceiver 28A and a Bluetooth (near field communication) transceiver 30A. Each of these components may be powered by a battery 34A, but other power sources may be used as available. The second user device 10B is shown with an optional network input/output port 36 that can communication with a network 40 via a landline 38.

As shown, various embodiments of the invention may utilize the cellular transceiver 28A to communicate with over a wireless or mobile communications network 40 using a nearby cellular communications tower 44. Using an application 16A, 16B, such as a web browser, a user may enter a request for data into a user device. If the request is communicated over the wireless communications network 40, an internet service provider (ISP) 42 may pass along the requested data from a website 102 in some embodiments of the invention. In particular, one of the user devices 10A, 10B may download data from the website 102 via the wireless communications network 40. This data may be cached in memory 14A, 14B as “cached data” 17A, 17B.

Furthermore, the two user devices 10A, 10B may communication directly using the Bluetooth transceivers 30A, 30B. Bluetooth may be used to advertise metadata stored with the cached data 17A, 17B, and/or Bluetooth may be used to search metadata when a first user device requests data. If the Bluetooth or near field communications enable a first user device to identify contextually similar data in one of the other user devices (i.e., a second user device), then the second user device 10B can provide the requested data to the first user device 10A without involving the wireless communications network 40, the ISP 42, or the website 102. Where there are multiple sources of suitable data, the first user device 10A may provide a prompt on the display 18A allowing the user to select which source should provide the requested data.

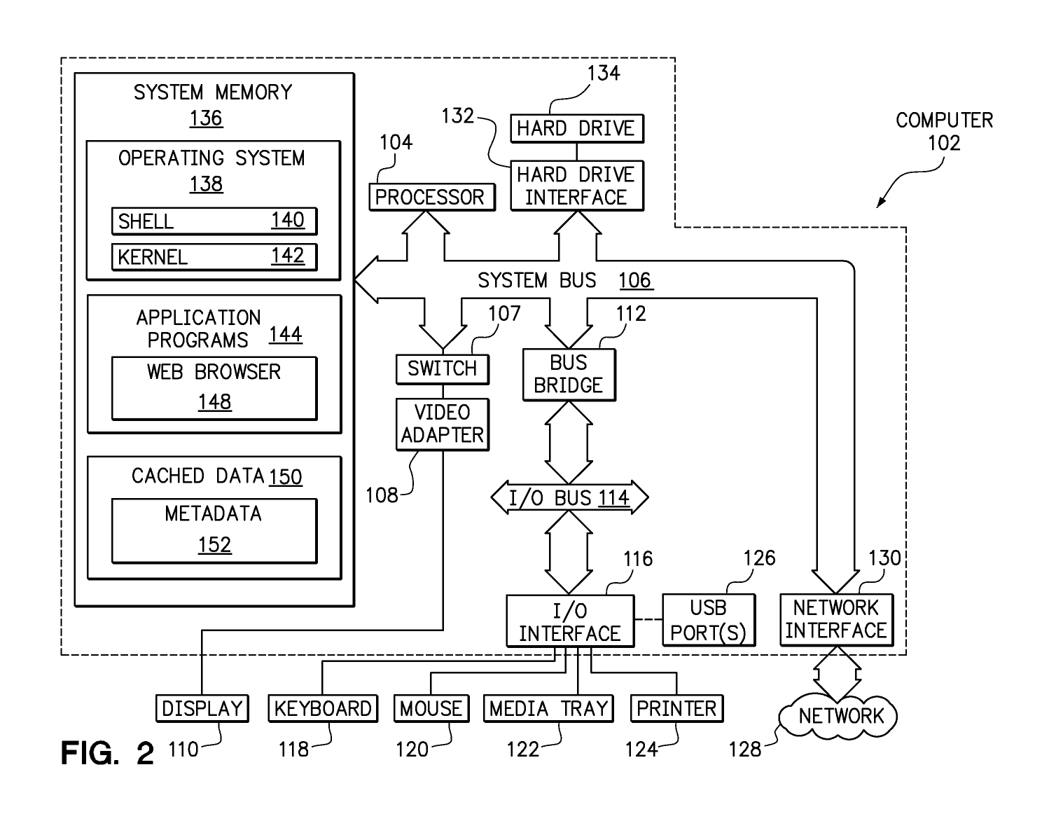

FIG. 2 is a diagram of an exemplary user device (computer) 102 that may be utilized in accordance with one or more embodiments of the present invention. Note that some or all of the exemplary architecture, including both depicted hardware and software, shown for and within computer 102 may be implemented in an alternative embodiment of the user devices in FIG. 1.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, the computer 102 is able to communicate over a network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management. Application programs 144 in the system memory of computer 102 may include a web browser 148 that can be used to submit and fulfill data requests in accordance with the present invention. The system memory 136 will also include the cached data 150, including the metadata 152 that describes the data 150. The hardware elements depicted in computer 102 are not intended to be exhaustive, but rather are representative components suitable to perform the processes of the present invention. For instance, computer 102 may include alternate memory storage devices such as magnetic cassettes, digital versatile disks (DVDs), Bernoulli cartridges, and the like. These and other variations are intended to be within the spirit and scope of the present invention.

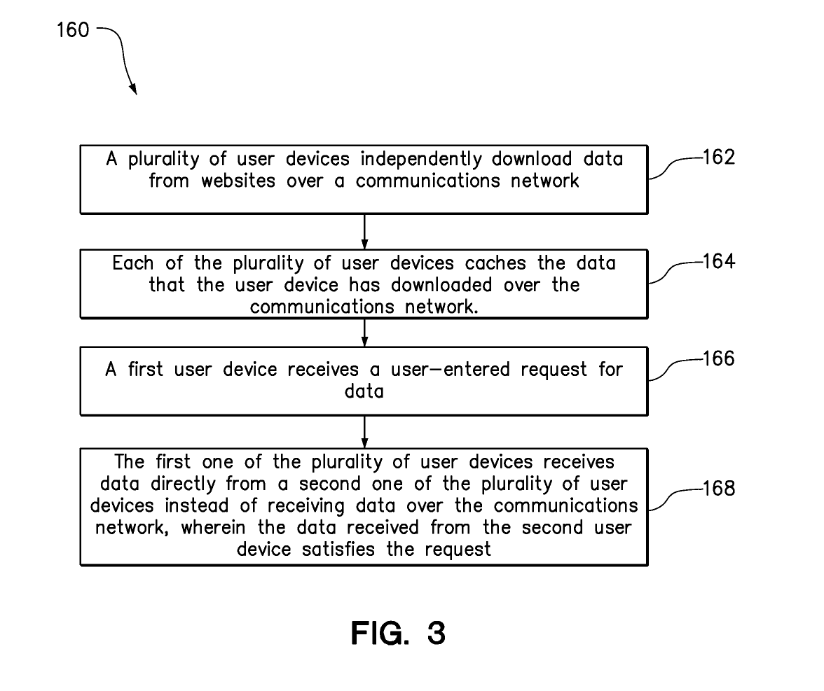

FIG. 3 is a flowchart of a method 160 in accordance with one embodiment of the present invention. In step 162, the method includes a plurality of user devices independently download data from web sites over a communications network. In step 164, each of the plurality of user devices caches the data that the user device has downloaded over the communications network. In step 166, a first user device receives a user-entered request for data. Then, in step 168, the first one of the plurality of user devices receives data directly from a second one of the plurality of user devices instead of receiving data over the communications network, wherein the data received from the second user device satisfies the request.

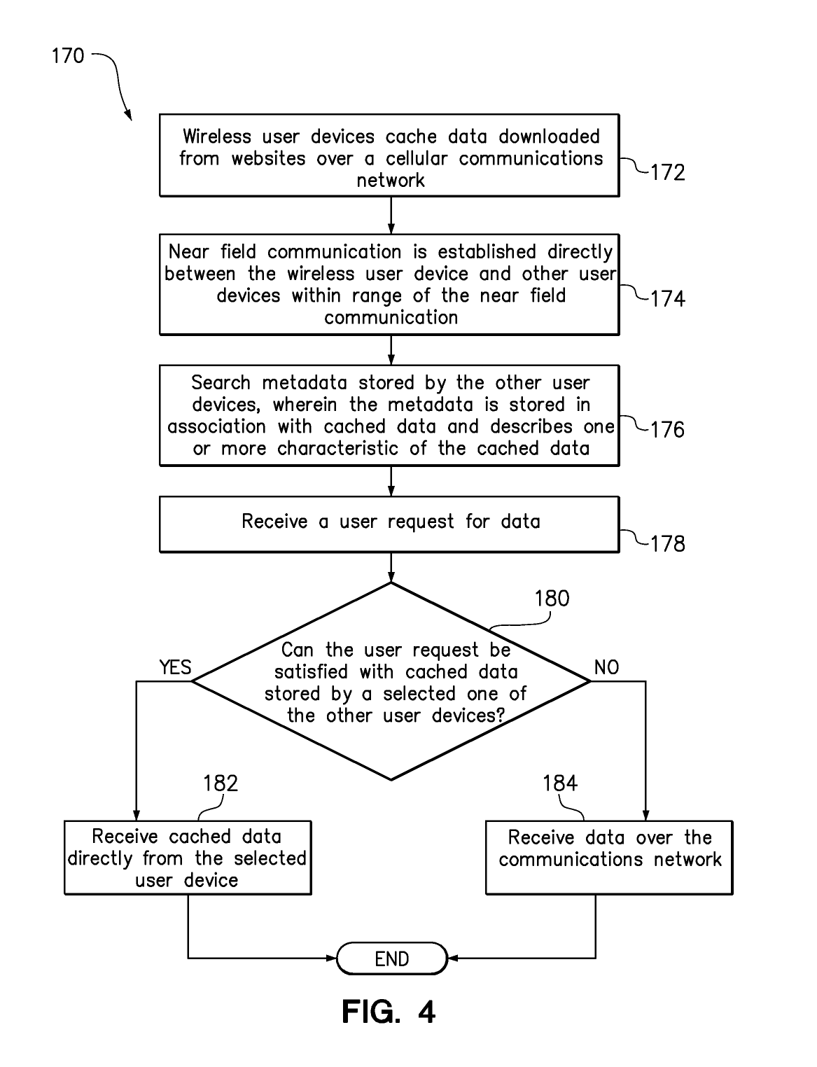

FIG. 4 is a flowchart of a method 170 in accordance with another embodiment of the present invention. In step 172, wireless user devices cache data downloaded from websites over a cellular communications network. In step 174, near field communication is established directly between a wireless user device and other user devices within range of the near field communication. Metadata stored by the other user devices is searched in step 176, wherein the metadata is stored in association with cached data and describes one or more characteristic of the cached data. After receiving a user request for data in step 178, step 180 determined whether the user request can be satisfied with cached data stored by a selected one of the other user devices. If a selected user device has cached data that can satisfy the request, then the cached data is received directly from the selected user device in step 182. If not, then the data is received over the communications network in step 184.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
a plurality of user devices independently downloading data from websites over a communications network in response to user-entered requests for data;
each of the plurality of user devices caching the data that the user device has downloaded over the communications network; and
a first one of the plurality of user devices, in response to a first user entering a request for data, receiving data directly from a second one of the plurality of user devices instead of receiving data over the communications network, wherein the data received from the second user device satisfies the request.

2. The method of claim 1, wherein each of the plurality of user devices caching the data that the user device has downloaded over the communications network includes each of the plurality of user devices selectively caching the data that the user device has downloaded over the communications network.

3. The method of claim 2, wherein the plurality of user devices selectively cache data that includes a single file having greater than a predetermined quantity of data.

4. The method of claim 1, further comprising:
each of the plurality of user devices storing the cached data in association with metadata describing one or more characteristic of the cached data.

5. The method of claim 4, wherein the one or more characteristic of the cached data is selected from context, keywords, source, timestamp, and combinations thereof.

6. The method of claim 1, further comprising:
the first user device caching the data received directly from the second user device.

7. The method of claim 6, further comprising:
a third one of the plurality of user devices, in response to a third user entering a request for data, automatically receiving data directly from the first user device instead of receiving data over the communications network, wherein the data received directly from the first user device satisfies the request and is the same data that the first user device previously received directly from the second user device.

8. The method of claim 4, further comprising:
advertising the metadata stored on each of the plurality of user devices to the rest of the plurality of user devices; and
the first user device searching the advertised metadata stored on each of the plurality of user devices to locate metadata indicating that the associated data would satisfy the request, wherein the data that the first user device receives directly from the second user device is identified by being associated with the located metadata.

9. The method of claim 8, wherein the metadata is advertised using a near field communication signal to those user devices within range of the near field communication signal.

10. The method of claim 1, wherein the first and second user devices exchange data directly using near field communication.

11. The method of claim 1, wherein the request for data includes entering a uniform resource locator into a web browser.

12. The method of claim 4, wherein the data is cached for a predetermined period of time.

13. The method of claim 4, wherein the data is cached for a predetermined period of time, wherein the predetermined period of time varies according to the type or source of the data.

14. The method of claim 4, further comprising:
advertising the metadata stored on each of the plurality of user devices to the rest of the plurality of user devices; and
the first user device searching the advertised metadata stored on each of the plurality of user devices to locate metadata indicating that the associated data is contextually similar to the requested data, wherein the data that the first user device automatically receives directly from the second user device is identified by being associated with the located metadata.

15. The method of claim 14, wherein the data is contextually similar to the requested data when the metadata contains one or more keywords in the request.

16. The method of claim 14, wherein the data is contextually similar to the requested data when the metadata indicates that the source provides data of the same type as the data requested.

17. The method of claim 1, further comprising:
displaying a prompt on the first user device allowing the first user to select whether to receive data directly from the second device or receive data from the communications network.

18. The method of claim 17, wherein the prompt that is displayed on the first user device identifies the data that is available from the second device.

19. The method of claim 1, further comprising:
identifying, from among the plurality of user devices, multiple user devices having data that is contextually similar to the data requested;
displaying a prompt on the first user device allowing the first user to select a user device from among the multiple user devices, wherein the first user device receives data directly from the selected user device.

20. The method of claim 19, wherein the prompt that is displayed on the first user device identifies the data that is available from each of the multiple user devices.

21. The method of claim 20, wherein the prompt that is displayed on the first user device further identifies, for each of the multiple user devices, a device type, proximity, strength of signal, or combination thereof.

22. The method of claim 19, further comprising:
the first user device storing a list of data sources that, when identified in the metadata, make data unacceptable regardless of the data being contextually similar.

23. The method of claim 1, further comprising:
receiving user input enabling the first user device to share cached data; and
increasing the amount of data cached by the first user device in response to enabling the first user device to share cached data.

24. The method of claim 1, further comprising:
a local server of an internet service provider communicating the downloading data from the websites to the plurality of user devices;
the local server caching the data that is being downloaded; and
a first one of the plurality of user devices, in response to a first user entering a request for data, receiving data directly from the local server instead of receiving data from the website, wherein the data received from the local server satisfies the request.

25. The method of claim 24, further comprising:
identifying, from among the plurality of user devices and a local server, multiple sources having data that is contextually similar to the data requested;
displaying a prompt on the first user device allowing the first user to select a source from among the multiple sources, wherein the first user device receives data directly from the selected source.
